(19) United States
(12) Patent Application Publication
(10) Pub. No.: US 2025/0080295 A1
(43) Pub. Date: Mar. 6, 2025

(54) Distributed-Tone Resource Unit Based Enhanced Long Range Communication Schemes In WLAN

(71) Applicant: MediaTek Inc., Hsinchu City (TW)

(72) Inventors: Jianhan Liu, San Jose, CA (US); Shengquan Hu, San Jose, CA (US); Thomas Edward Pare, JR., San Jose, CA (US)

(21) Appl. No.: 18/817,198

(22) Filed: Aug. 27, 2024

Related U.S. Application Data
(60) Provisional application No. 63/579,966, filed on Sep. 1, 2023.

(51) Int. Cl. H04L 5/00; H04W 28/26

(52) U.S. Cl. CPC H04L 5/0048; H04W 28/26

(57) ABSTRACT

Various schemes pertaining to distributed-tone resource unit (DRU)-based enhanced long range (ELR) communication schemes in wireless local area networks (WLANs) are described. An apparatus (e.g., an access point (AP) or a non-AP station (STA)) generates a DRU-based PPDU. The apparatus transmits the PPDU in an ELR communication.

### CROSS REFERENCE TO RELATED PATENT APPLICATION

The present disclosure is part of a non-provisional patent application claiming the priority benefit of U.S. Provisional Patent Application No. 63/579,966, filed 1 Sep. 2023, the content of which being incorporated by reference in its entirety.

### TECHNICAL FIELD

The present disclosure is generally related to wireless communications and, more particularly, to distributed-tone resource unit (DRU)-based enhanced long range (ELR) communication schemes in wireless local area networks (WLANs).

### BACKGROUND

Unless otherwise indicated herein, approaches described in this section are not prior art to the claims listed below and are not admitted as prior art by inclusion in this section.

In wireless communications such as Wi-Fi (or WiFi) and WLAN systems in accordance with one or more Institute of Electrical and Electronics Engineers (IEEE) 802.11 standards, wireless applications such as wireless video surveillance, wireless video doorbells and Internet-of-Things (IoT) devices require ELR communication schemes in WLAN. In general, an access point (AP) can transmit at a higher power than a station (STA), so there tends to be downlink (DL) and uplink (UL) range imbalance. In that regard, ELR communication schemes can compensate the DL and UL range imbalance. In the European Union (EU), Japan, China and South Korea, the regulated transmit power spectrum density is lower than that in the United States and, thus, in order to extend the range in those regions/countries with lower regulated transmit power spectrum density, ELR communication schemes are also needed. Besides, ELR communication schemes that are superior to the IEEE 802.11b-based scheme are direly needed for at least the following reasons. Firstly, in WLANs based on the IEEE 802.11 standards family, the prevailing long-range scheme is IEEE 802.11b-based technology. However, IEEE 802.11b is a single-carrier, complementary code keying (CCK) modulated communication scheme that was invented in 1999. As such, long range communications based on IEEE 802.11b tend to suffer low spectrum efficiency and poor network management. There needs to be ways to provide higher spectrum efficiency, better network management and longer coverage/higher data rate. Therefore, there is a need for a solution of DRU-based ELR communication schemes in WLANs.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to DRU-based ELR communication schemes in WLANs. It is believed that implementations of the various schemes proposed herein may address or otherwise alleviate the aforementioned issues.

In one aspect, a method may involve generating a DRU-based PPDU. The method may also involve transmitting the PPDU in an ELR communication.

In another aspect, an apparatus may include a transceiver configured to communicate wirelessly and a processor coupled to the transceiver. The processor may generate a DRU-based PPDU. The processor may also transmit the PPDU in an ELR communication.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a block diagram of an example communication system under a proposed scheme in accordance with the present disclosure.

FIG. 14 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to DRU-based ELR communication schemes in WLANs. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU or RU) refers to a RU with tones that are continuous (e.g., immediately adjacent to one another) and not interleaved, interlaced or otherwise distributed. Moreover, a 13-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, a distributed-tone RU (DRU) refers to a RU with tones that are non-discontinuous (e.g., not immediately adjacent to one another) and interleaved, interlaced or otherwise distributed. Accordingly, a 13-tone distributed-tone RU may be interchangeably denoted as DRU26, a 52-tone distributed-tone RU may be interchangeably denoted as DRU52, a 106-tone distributed-tone RU may be interchangeably denoted as DRU106, a 242-tone distributed-tone RU may be interchangeably denoted as DRU242, a 484-tone distributed-tone RU may be interchangeably denoted as DRU484, a 996-tone distributed-tone RU may be interchangeably denoted as DRU996, a 2x996-tone distributed-tone RU may be interchangeably denoted as DRU2x996, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

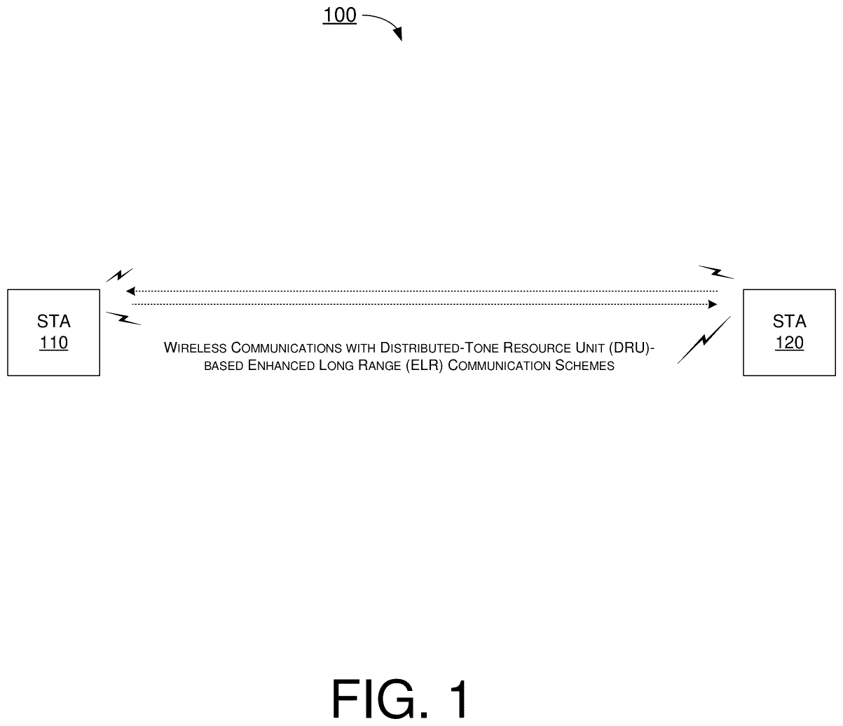

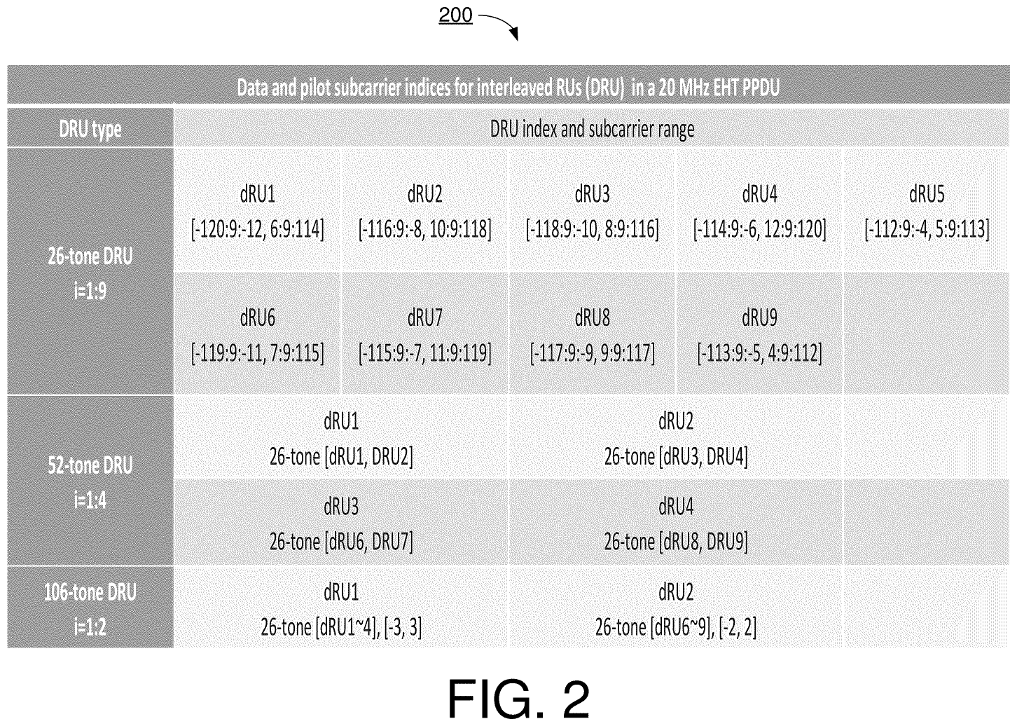

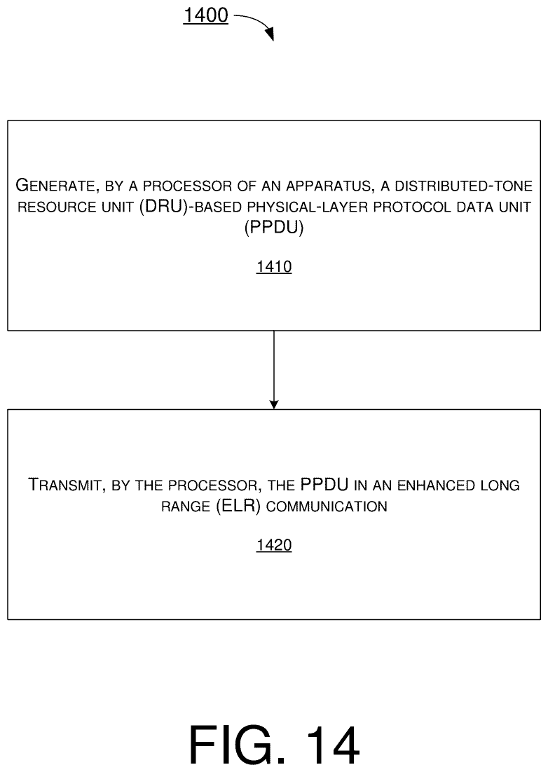

FIG. 1 illustrates an example network environment 100 in which various solutions and schemes in accordance with the present disclosure may be implemented. FIG. 2˜FIG. 14 illustrate examples of implementation of various proposed schemes in network environment 100 in accordance with the present disclosure. The following description of various proposed schemes is provided with reference to FIG. 1˜FIG. 14.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the DRU-based ELR communication schemes in WLANs in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In different regions, regulations impose different power spectral density (PSD) limitations on the 2.4 GHz, 5 GHz and 6 GHz frequency bands. The PSD limitations are defined per MHz and for each STA. To overcome the PSD limitations and boost the transmit power, under various proposed schemes in accordance with the present disclosure, tones of a small-sized resource unit (RU) may be distributed over a wide bandwidth. Accordingly, the tones for each STA may become non-contiguous and therefore each tone may be transmitted with a higher power. For a STA (e.g., STA 110) to transmit a DRU, it may transmit at a much higher power compared to that used in transmitting a regular RU, which involves transmission on a group of contiguous tones.

FIG. 2 illustrates an example design 200 under a proposed scheme in accordance with the present disclosure. Design 200 may pertain to DRUs in the 20 MHz bandwidth. Under the proposed scheme, DRUs may be defined over different bandwidths. The table in FIG. 2 shows designs of 13-tone, 52-tone and 106-tone DRUs over a 20 MHz bandwidth. An alternative design may involve simply uniformly distributed tones over a 20 MHz channel. For instance, in distributing the tones of a DRU, a STA (e.g., STA 110) may select only one tone for transmission among N consecutive tones, with N=2, 4, 6, . . .

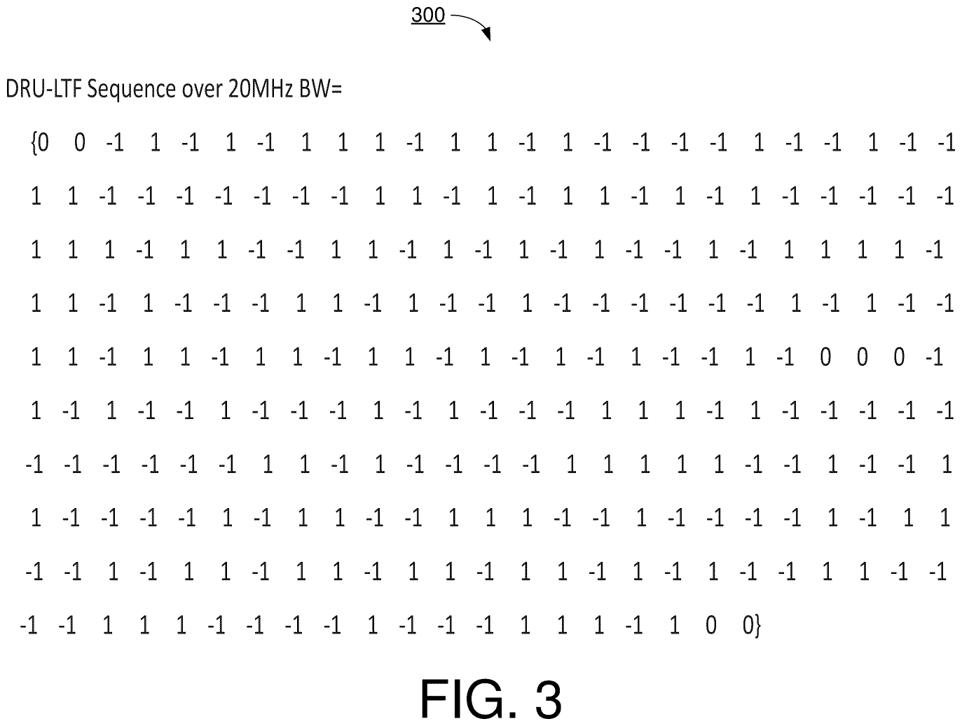

FIG. 3 illustrates an example design 300 under a proposed scheme in accordance with the present disclosure. Design 300 may pertain to a distributed-tone long training field (LTF) for 20 MHz bandwidth. Under the proposed scheme, to reduce the peak-to-average power ratio (PAPR), a new DRU-LTF sequence may be defined, such as that shown in FIG. 3. Each STA may only transmit the tones in the DRU-LTF sequence mapping to the tones occupied by the DRU used by the STA. The example shown in FIG. 3 may be a DRU-LTF design for 20 MHz bandwidth transmission.

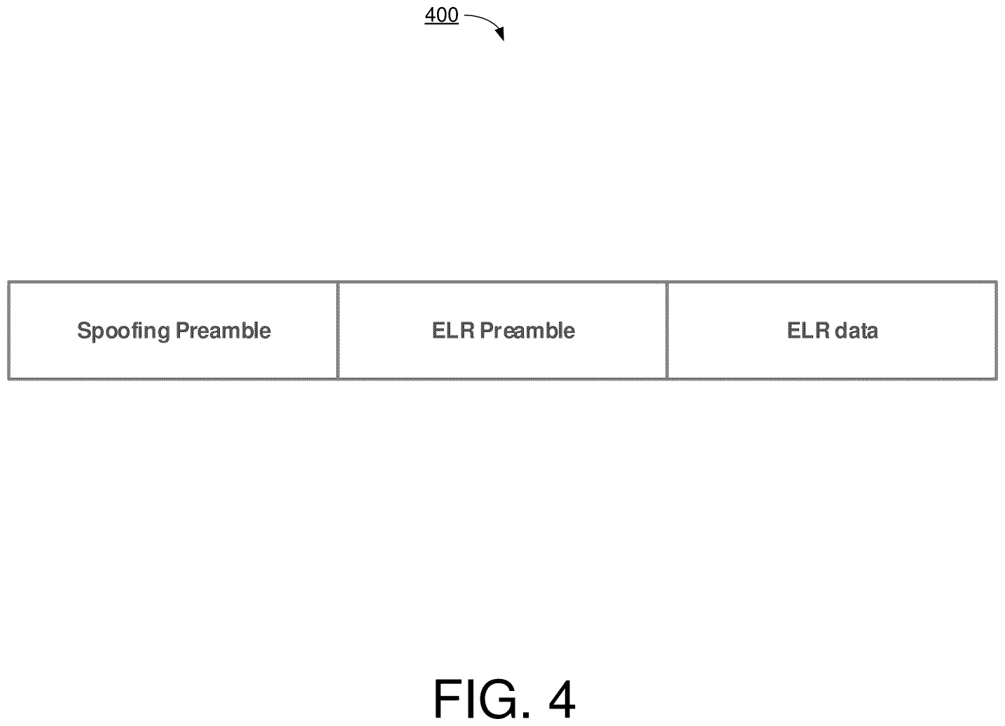

FIG. 4 illustrates an example design 400 under a proposed scheme in accordance with the present disclosure. Design 400 may pertain to an ELR single-user (SU) physical-layer protocol data unit (PPDU) design. Under the proposed scheme, ELR PPDUs may use orthogonal frequency-division multiplexing (OFDM) modulations in preamble signal fields and the data portion thereof. Referring to FIG. 4, each ELR PPDU may be composed of multiple functional blocks, including: spoofing preamble, ELR preamble, and ELR data.

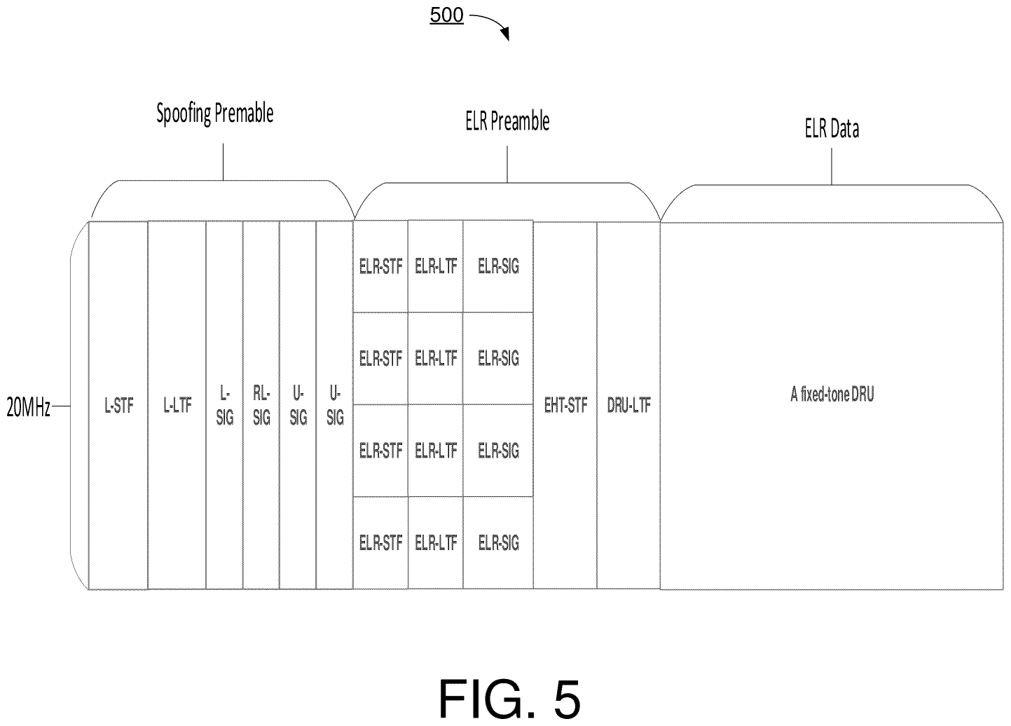

FIG. 5 illustrates an example design 500 under a proposed scheme in accordance with the present disclosure. Design 500 may pertain to a first ELR SU PPDU design. In design 500, the ELR short training field (ELR-STF) and ELR long training field (ELR-LTF) may be the downclocked version of legacy short training field (L-STF) and legacy long training field (L-LTF) from IEEE 802.11a/n/ac, respectively. The ELR-STF may be 4×, 8× or 10× downclocked from a 20 MHz L-STF sequence. The ELR-LTF may be 4×, 8× or 10× downclocked from a 20 MHz L-LTF sequence. The ELR-STF and ELR-LTF may be duplicated 4, 8 or 10 times in the frequency domain to enhance the transmission range. In design 500, the ELR signal (ELR-SIG) may be duplicated in the frequency domain to carry the required information for ELR data, such as modulation and coding scheme (MCS), coding, and so forth. The EHT-STF may be used in the ELR preamble. The DRU-LTF may be used for channel estimation for DRUs. The ELR data may be transmitted over a DRU with a fixed size and tone plan, for example, and it may be a 13-tone DRU, 52-tone DRU or a DRU of another size.

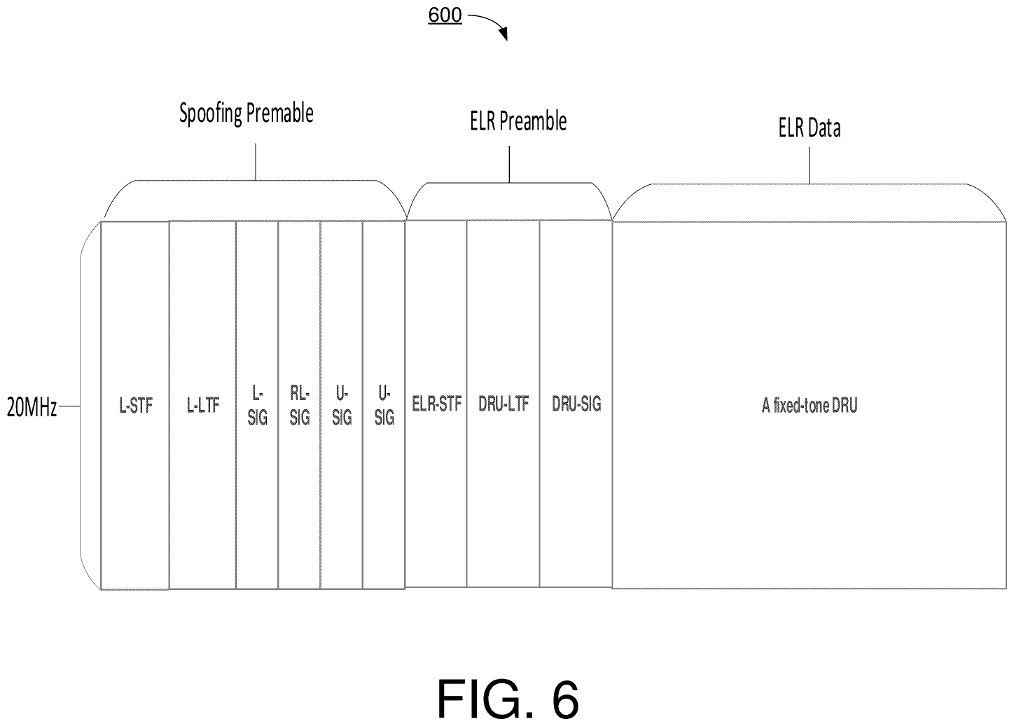

FIG. 6 illustrates an example design 600 under a proposed scheme in accordance with the present disclosure. Design 600 may pertain to a second ELR SU PPDU design. In design 600, the ELR-STF may be a Golay sequence or other downclocked frequency-domain duplicated sequences over 20 MHz used for packet detection and time synchronization. The DRU-LTF may be used for channel estimation for distributed-tone RU. The DRU-SIG may use a fixed DRU with the fixed modulation, and the DRU-SIG may be used to carry the required information for ELR data, such as MCS, coding, and so on. The ELR data may be transmitted over a DRU with a fixed size and tone plan, for example, and it may be a 13-tone DRU, 52-tone DRU or a DRU of another size.

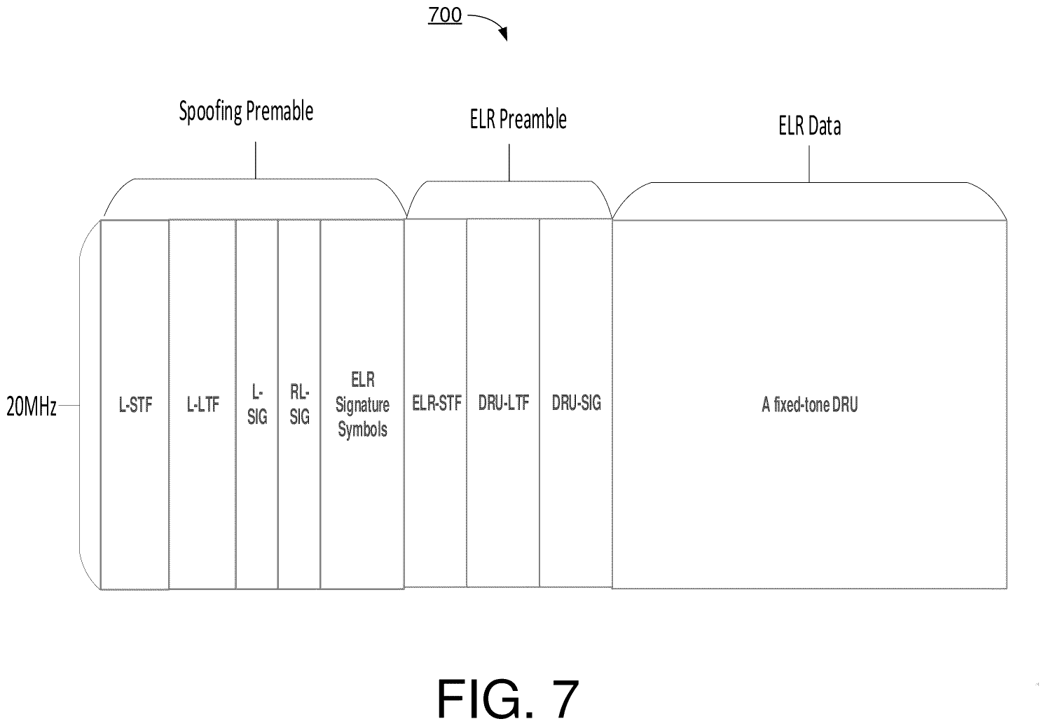

FIG. 7 illustrates an example design 700 under a proposed scheme in accordance with the present disclosure. Design 700 may pertain to a variation of the second ELR SU PPDU design. In design 700, the universal signal (U-SIG) fields may be replaced with ELR signature symbols for ELR format detection. The ELR signature symbols may be like U-SIGs but with a predetermined sequence. The DRU-SIG may use a fixed DRU with a fixed modulation. The DRU-SIG may be used to carry the required information for ELR data, such as MCS, coding, and so on. The ELR data may be transmitted over a DRU with a fixed size and tone plan, for example, and it may be a 13-tone DRU, 52-tone DRU or a DRU of another size.

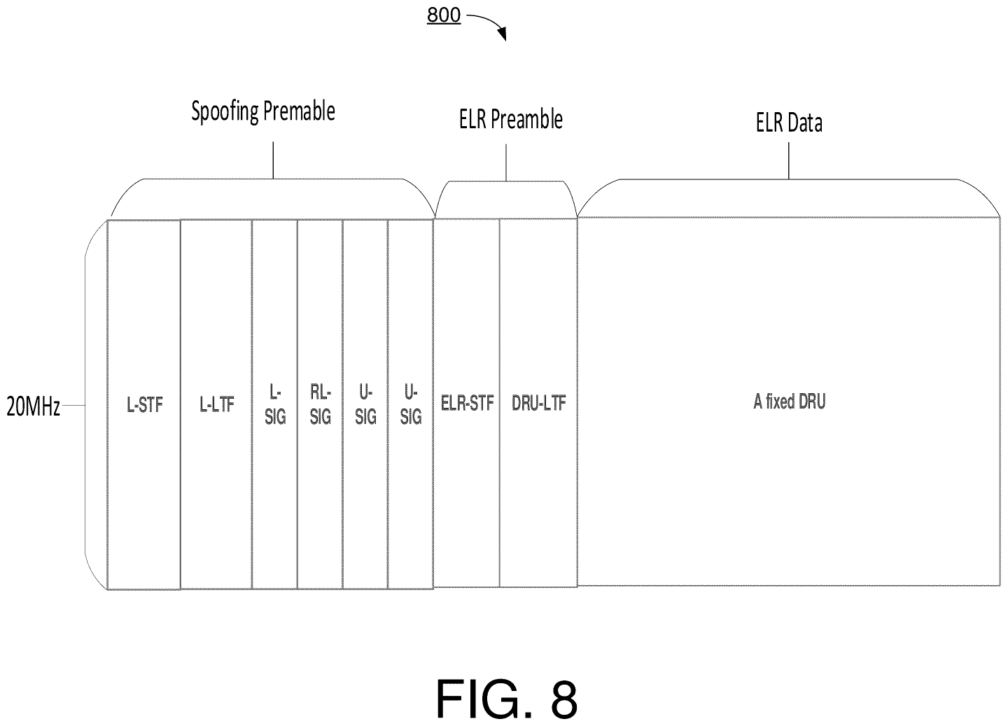

FIG. 8 illustrates an example design 800 under a proposed scheme in accordance with the present disclosure. Design 800 may pertain to a third ELR SU PPDU design. In design 800, in case that ELR SU only uses one fixed DRU and one fixed modulation, the ELR-SIG may be removed. The ELR-STF may be a Golay sequence or other sequency over 20 MHz used for packet detection and time synchronization. The DRU-LTF may be used for channel estimation for distributed-tone RU. The ELR data may be transmitted over a DRU. In case that ELR SU only uses a few fixed DRUs and modulations, the ELR-SIG may be removed, and the DRU and modulation indication may be carried by multiple ELR-STFs. For example, ELR-STF-A may indicate a fixed 13-tone RU with a first MCS (e.g., MCS0), and ELR-STF-B may indicate a fixed 13-tone RU with a second MCS (e.g., MCS1).

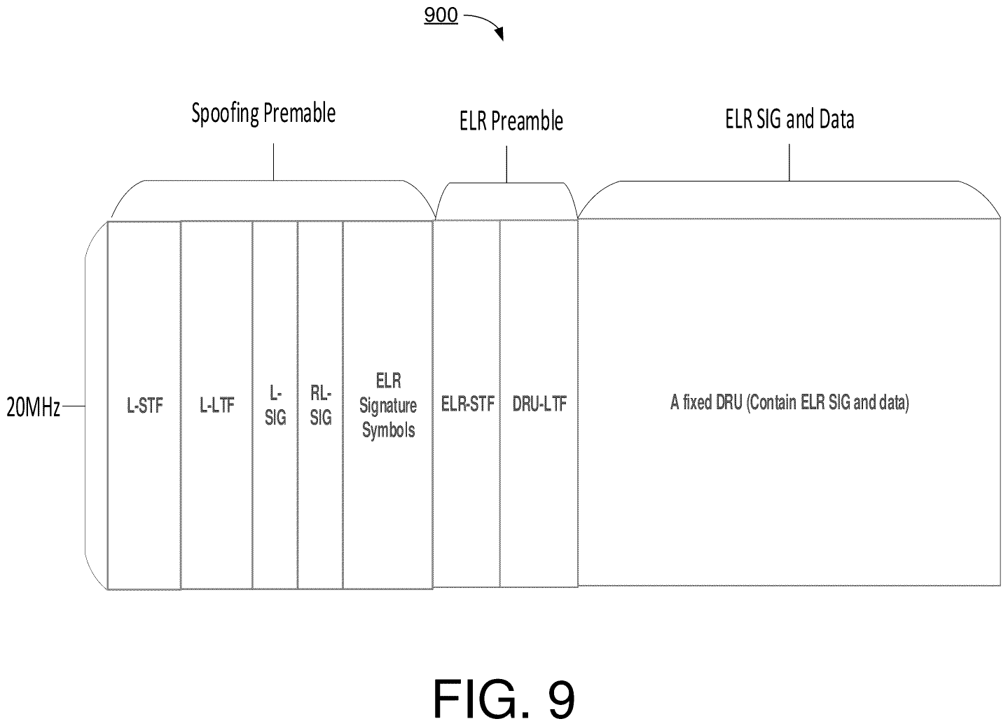

FIG. 9 illustrates an example design 900 under a proposed scheme in accordance with the present disclosure. Design 900 may pertain to a variation of the third ELR SU PPDU design. In design 900, the U-SIGs may be replaced with ELR signature symbols for ELR format detection, and the ELR signature symbols may be like U-SIGs but with a predetermined sequence. The ELR SU may only use one fixed DRU, and ELR Signal fields may be transmitted with the lowest MCS used for ELR. The ELR data may be transmitted following the ELR Signal field.

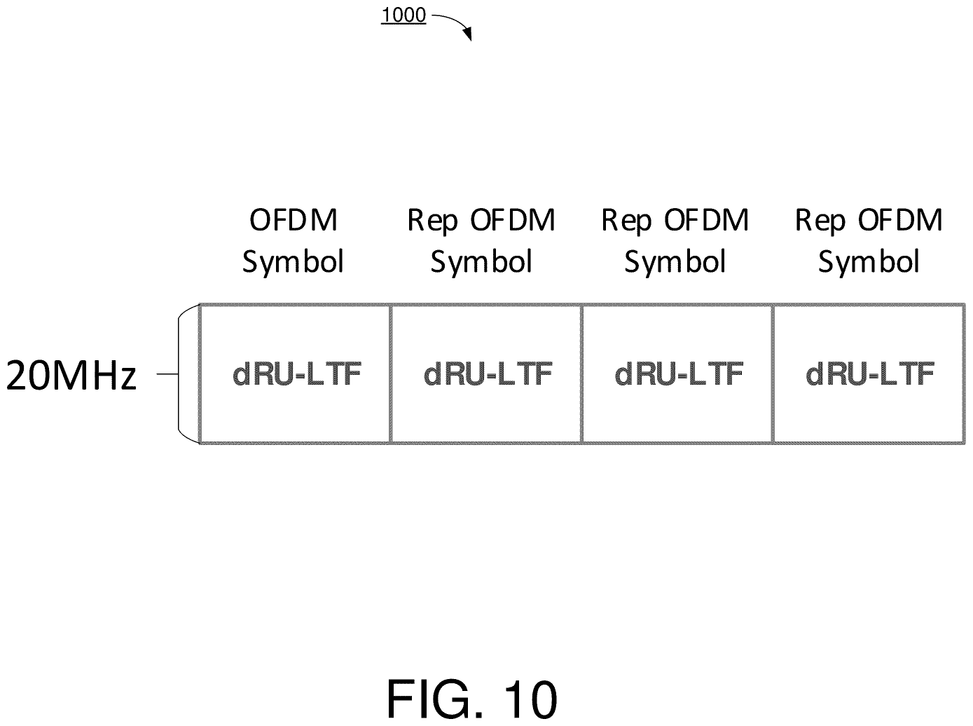

FIG. 10 illustrates an example design 1000 under a proposed scheme in accordance with the present disclosure. Design 1000 may pertain to DRU-LTF repetition for enhanced channel estimation. In general, there are challenges on channel estimation for ELR PPDUs. For instance, for ELR, the received signal-to-noise ratio (SNR) tends to be very low and it is challenging to obtain accurate channel estimation with low SNR. Moreover, for distributed-tone LTF, it tends to be more difficult to apply smoothing techniques to enhance channel estimation. In design 1000, the DRU-LTF may be repeated in the time domain for multiple times, as shown in FIG. 10, to help enhance channel estimation.

Under a proposed scheme in accordance with the present disclosure, a trigger-based (TB) PPDU may be modified to include DRU to enhance transmission range. For instance, an AP (e.g., STA 120) may send a trigger to ELR STA(s) to trigger ELR TB PPDU. Each of the ELR STAs may send an ELR TB PPDU using an assigned DRU in the received trigger. The AP may also send an UL orthogonal frequency-division multiple-access (OFDMA)-based random access (UORA) trigger to trigger ELR TB PPDU(s). Each of the ELR STAs may send an ELR TB PPDU using a randomly selected DRU.

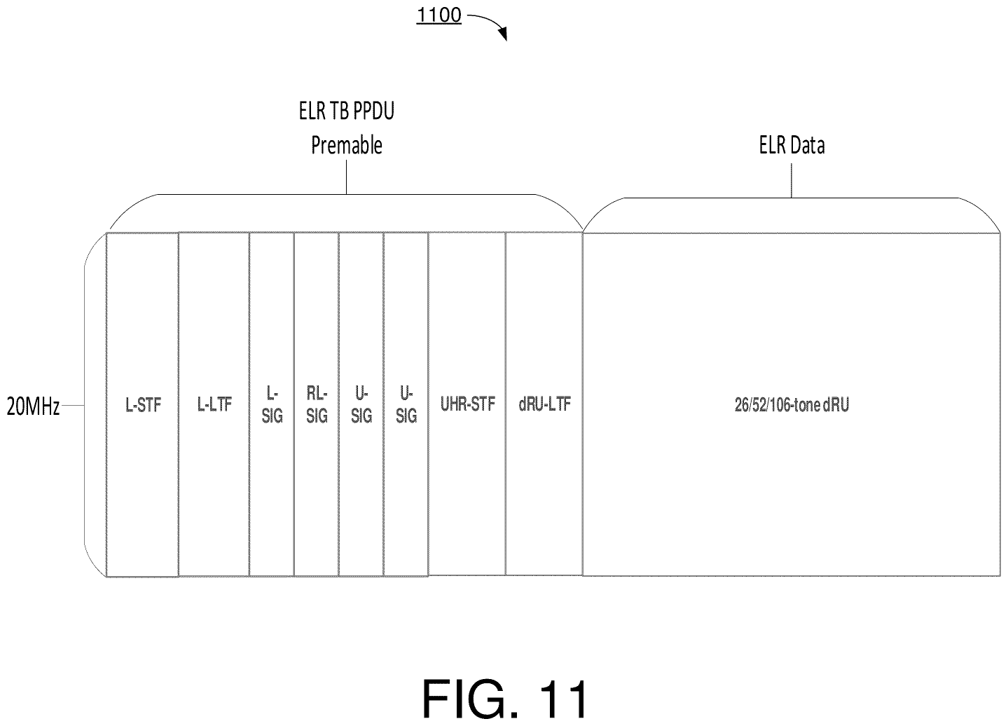

FIG. 11 illustrates an example design 1100 under a proposed scheme in accordance with the present disclosure. Design 1100 may pertain to a first ELR TB PPDU design. In design 1100, an ELR TB PPDU may include an ELR TB Preamble which may include the L-STF, L-LTF, L-SIG, repeated legacy signal (RL-SIG), U-SIG, ultra-high-reliability long training field (UHR-LTF) and DRU-LTF. The UHR-LTF may be the same as an EHT-LTF designed in IEEE 802.11be. The DRU-LTF may be a time domain-repeated version of DRU-LTF.

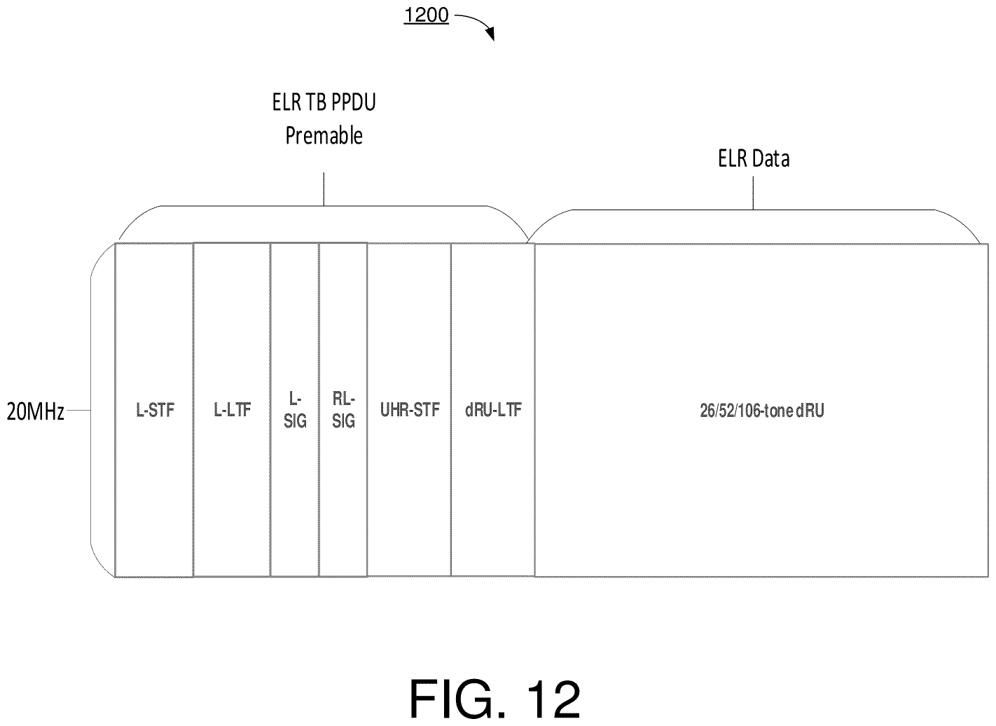

FIG. 12 illustrates an example design 1200 under a proposed scheme in accordance with the present disclosure. Design 1200 may pertain to a second ELR TB PPDU design. In design 1200, an ELR TB PPDU may include an ELR TB Preamble which may include the, L-STF, L-LTF, L-SIG, UHR-LTF and DRU-LTF. The UHR-LTF may be the same as an EHT-LTF designed in IEEE 802.11be. The DRU-LTF may be a time domain-repeated version of DRU-LTF.

### Illustrative Implementations

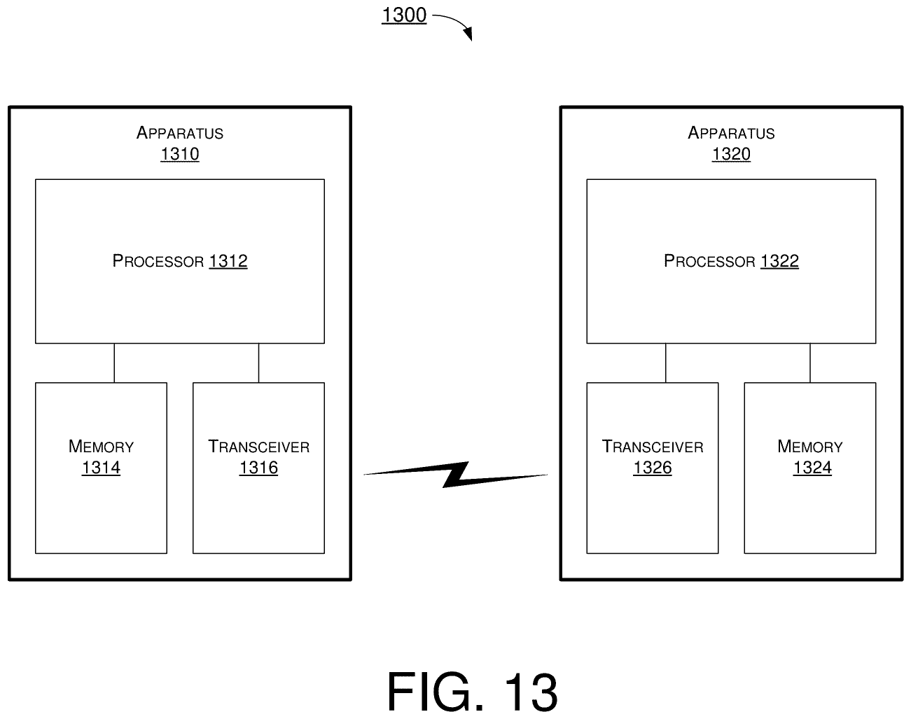

FIG. 13 illustrates an example system 1300 having at least an example apparatus 1310 and an example apparatus 1320 in accordance with an implementation of the present disclosure. Each of apparatus 1310 and apparatus 1320 may perform various functions to implement schemes, techniques, processes and methods described herein pertaining to DRU-based ELR communication schemes in WLANs, including the various schemes described above with respect to various proposed designs, concepts, schemes, systems and methods described above as well as processes described below. For instance, apparatus 1310 may be implemented in STA 110 and apparatus 1320 may be implemented in STA 120, or vice versa.

Each of apparatus 1310 and apparatus 1320 may be a part of an electronic apparatus, which may be a STA or an AP, such as a portable or mobile apparatus, a wearable apparatus, a wireless communication apparatus or a computing apparatus. When implemented in a STA, each of apparatus 1310 and apparatus 1320 may be implemented in a smartphone, a smart watch, a personal digital assistant, a digital camera, or a computing equipment such as a tablet computer, a laptop computer or a notebook computer. Each of apparatus 1310 and apparatus 1320 may also be a part of a machine type apparatus, which may be an IoT apparatus such as an immobile or a stationary apparatus, a home apparatus, a wire communication apparatus or a computing apparatus. For instance, each of apparatus 1310 and apparatus 1320 may be implemented in a smart thermostat, a smart fridge, a smart door lock, a wireless speaker or a home control center. When implemented in or as a network apparatus, apparatus 1310 and/or apparatus 1320 may be implemented in a network node, such as an AP in a WLAN.

In some implementations, each of apparatus 1310 and apparatus 1320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1310 and apparatus 1320 may be implemented in or as a STA or an AP. Each of apparatus 1310 and apparatus 1320 may include at least some of those components shown in FIG. 13 such as a processor 1312 and a processor 1322, respectively, for example. Each of apparatus 1310 and apparatus 1320 may further include one or more other components not pertinent to the proposed scheme of the present disclosure (e.g., internal power supply, display device and/or user interface device), and, thus, such component(s) of apparatus 1310 and apparatus 1320 are neither shown in FIG. 13 nor described below in the interest of simplicity and brevity.

In one aspect, each of processor 1312 and processor 1322 may be implemented in the form of one or more single-core processors, one or more multi-core processors, one or more RISC processors or one or more CISC processors. That is, even though a singular term “a processor” is used herein to refer to processor 1312 and processor 1322, each of processor 1312 and processor 1322 may include multiple processors in some implementations and a single processor in other implementations in accordance with the present disclosure. In another aspect, each of processor 1312 and processor 1322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1312 and processor 1322 is a special-purpose machine specifically designed, arranged and configured to perform specific tasks including those pertaining to DRU-based ELR communication schemes in WLANs in accordance with various implementations of the present disclosure.

In some implementations, apparatus 1310 may also include a transceiver 1316 coupled to processor 1312. Transceiver 1316 may include a transmitter capable of wirelessly transmitting and a receiver capable of wirelessly receiving data. In some implementations, apparatus 1320 may also include a transceiver 1326 coupled to processor 1322. Transceiver 1326 may include a transmitter capable of wirelessly transmitting and a receiver capable of wirelessly receiving data. It is noteworthy that, although transceiver 1316 and transceiver 1326 are illustrated as being external to and separate from processor 1312 and processor 1322, respectively, in some implementations, transceiver 1316 may be an integral part of processor 1312 as a system on chip (SoC) and/or transceiver 1326 may be an integral part of processor 1322 as a SoC.

In some implementations, apparatus 1310 may further include a memory 1314 coupled to processor 1312 and capable of being accessed by processor 1312 and storing data therein. In some implementations, apparatus 1320 may further include a memory 1324 coupled to processor 1322 and capable of being accessed by processor 1322 and storing data therein. Each of memory 1314 and memory 1324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1314 and memory 1324 may include a type of read-only memory (ROM) such as mask ROM, programmable ROM (PROM), erasable programmable ROM (EPROM) and/or electrically erasable programmable ROM (EEPROM). Alternatively, or additionally, each of memory 1314 and memory 1324 may include a type of non-volatile random-access memory (NVRAM) such as flash memory, solid-state memory, ferroelectric RAM (FeRAM), magnetoresistive RAM (MRAM) and/or phase-change memory.

Each of apparatus 1310 and apparatus 1320 may be a communication entity capable of communicating with each other using various proposed schemes in accordance with the present disclosure. For illustrative purposes and without limitation, a description of capabilities of apparatus 1310, as STA 110, and apparatus 1320, as STA 120, is provided below in the context of process 1400. It is noteworthy that, although a detailed description of capabilities, functionalities and/or technical features of apparatus 1310 is provided below, the same may be applied to apparatus 1320 although a detailed description thereof is not provided solely in the interest of brevity. It is also noteworthy that, although the example implementations described below are provided in the context of WLAN, the same may be implemented in other types of networks.

### Illustrative Processes

FIG. 14 illustrates an example process 1400 in accordance with an implementation of the present disclosure. Process 1400 may represent an aspect of implementing various proposed designs, concepts, schemes, systems and methods described above. More specifically, process 1400 may represent an aspect of the proposed concepts and schemes pertaining to DRU-based ELR communication schemes in WLANs in accordance with the present disclosure. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively, in a different order. Furthermore, one or more of the blocks/sub-blocks of process 1400 may be executed repeatedly or iteratively. Process 1400 may be implemented by or in apparatus 1310 and apparatus 1320 as well as any variations thereof. Solely for illustrative purposes and without limiting the scope, process 1400 is described below in the context of apparatus 1310 implemented in or as STA 110 and apparatus 1320 implemented in or as STA 120 of a wireless network such as a WLAN in network environment 100 in accordance with one or more of IEEE 802.11 standards. It is noteworthy that, although the description of process 1400 below is provided in the context of apparatus 1310 (implemented in or as a non-AP STA) performing various operations, the same may be applicable to apparatus 1320 (implemented in or as an AP STA). Process 1400 may begin at block 1410.

At 1410, process 1400 may involve processor 1312 of apparatus 1310 (e.g., STA 110) generating a DRU-based PPDU. Process 1400 may proceed from 1410 to 1420.

At 1420, process 1400 may involve processor 1312 transmitting, via transceiver 1316, the PPDU in an ELR communication with apparatus 1320.

In some implementations, the PPDU may include a plurality of functional blocks such as a spoofing preamble, an ELR preamble, and an ELR data.

In some implementations, in transmitting the PPDU, process 1400 may involve processor 1312 transmitting the ELR data over a DRU with a fixed size and tone plan.

In some implementations, the DRU may include a 26-tone DRU, a 52-tone DRU or a 106-tone DRU.

In some implementations, the ELR preamble may include a DRU-LTF sequence.

In some implementations, in transmitting the PPDU, process 1400 may involve processor 1312 duplicating the DRU-LTF multiple times in a time domain.

In some implementations, the ELR preamble may further include an ELR-STF, an ELR-LTF and an ELR-SIG.

In some implementations, each of the ELR-STF, the ELR-LTF and the ELR-SIG may be duplicated in a frequency domain.

In some implementations, the ELR preamble may further include a DRU-SIG using a DRU with a fixed modulation and carrying information related to the ELR data.

In some implementations, the spoofing preamble may include a sequence of ELR signature symbols indicating the PPDU as an ELR PPDU.

In some implementations, the PPDU may include an TB PPDU that includes an ELR TB PPDU preamble and an ELR data. In some implementations, in transmitting the PPDU, process 1400 may involve processor 1312 transmitting the ELR TB PPDU using an assigned DRU or a randomly selected DRU.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a distributed-tone resource unit (DRU)-based physical-layer protocol data unit (PPDU); and
transmitting, by the processor, the PPDU in an enhanced long range (ELR) communication.

2. The method of claim 1, wherein the PPDU comprises a plurality of functional blocks comprising a spoofing preamble, an ELR preamble, and an ELR data.

3. The method of claim 2, wherein the transmitting of the PPDU comprises transmitting the ELR data over a DRU with a fixed size and tone plan.

4. The method of claim 3, wherein the DRU comprises a 26-tone DRU, a 52-tone DRU or a 106-tone DRU.

5. The method of claim 2, wherein the ELR preamble comprises a DRU long training field (DRU-LTF) sequence.

6. The method of claim 5, wherein the transmitting of the PPDU comprises duplicating the DRU-LTF multiple times in a time domain.

7. The method of claim 5, wherein the ELR preamble further comprises an ELR short training field (ELR-STF), an ELR long training field (ELR-LTF) and an ELR signal field (ELR-SIG).

8. The method of claim 7, wherein each of the ELR-STF, the ELR-LTF and the ELR-SIG is duplicated in a frequency domain.

9. The method of claim 5, wherein the ELR preamble further comprises a DRU signal field (DRU-SIG) using a DRU with a fixed modulation and carrying information related to the ELR data.

10. The method of claim 5, wherein the spoofing preamble comprises a sequence of ELR signature symbols indicating the PPDU as an ELR PPDU.

11. The method of claim 1, wherein the PPDU comprises an ELR trigger-based (TB) PPDU comprising an ELR TB PPDU preamble and an ELR data.

12. The method of claim 11, wherein the transmitting of the PPDU comprises transmitting the ELR TB PPDU using an assigned DRU or a randomly selected DRU.

13. An apparatus, comprising:
a transceiver configured to communicate wirelessly; and
a processor coupled to the transceiver and configured to perform operations comprising:
generating a distributed-tone resource unit (DRU)-based physical-layer protocol data unit (PPDU); and
transmitting, via the transceiver, the PPDU in an enhanced long range (ELR) communication.

14. The apparatus of claim 13, wherein the PPDU comprises a plurality of functional blocks comprising a spoofing preamble, an ELR preamble, and an ELR data.

15. The apparatus of claim 14, wherein the transmitting of the PPDU comprises transmitting the ELR data over a DRU with a fixed size and tone plan, and wherein the DRU comprises a 26-tone DRU, a 52-tone DRU or a 106-tone DRU.

16. The apparatus of claim 14, wherein the ELR preamble comprises a DRU long training field (DRU-LTF) sequence.

17. The apparatus of claim 16, wherein the transmitting of the PPDU comprises duplicating the DRU-LTF multiple times in a time domain.

18. The apparatus of claim 16, wherein the ELR preamble further comprises an ELR short training field (ELR-STF), an ELR long training field (ELR-LTF) and an ELR signal field (ELR-SIG), and wherein each of the ELR-STF, the ELR-LTF and the ELR-SIG is duplicated in a frequency domain.

19. The apparatus of claim 16, wherein the ELR preamble further comprises a DRU signal field (DRU-SIG) using a DRU with a fixed modulation and carrying information related to the ELR data.

20. The apparatus of claim 16, wherein the spoofing preamble comprises a sequence of ELR signature symbols indicating the PPDU as an ELR PPDU.
